(19) United States
(12) Patent Application Publication
(10) Pub. No.: US 2006/0189271 A1
(43) Pub. Date: Aug. 24, 2006

(54) Display card with a wireless module

(75) Inventors: Chih-Peng Wu, Taipei (TW); Fou-Ming Liou, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/330,226

(22) Filed: Jan. 12, 2006

(30) Foreign Application Priority Data
Feb. 24, 2005 (TW) 94105690

(51) Int. Cl. H04H 1/00

(52) U.S. Cl. 455/3.01

(57) ABSTRACT

The present invention provides a display card with wireless communication functionality. A wireless module controlled by a graphic processing unit is formed in the display card. Audio-visual data is sent to the corresponding display through a wireless communication method by the display card. This display card can communicate with the motherboard through an interface. A software program is used to switch the transmission frequency.

### RELATED APPLICATIONS

The present application is based on, and claims priority from, Taiwan Application Serial Number 94105690, filed Feb. 24, 2005, the disclosure of which is hereby incorporated by reference herein in its entirety.

### FIELD OF THE INVENTION

The present invention regards a display card, and more particularly a display card with wireless functionality.

### BACKGROUND OF THE INVENTION

With developments in computer technology, people have come to use computers to process more and more daily work. Moreover, when a computer is connected to the Internet or a TV cable, various data may be transferred to the computer to inform and entertain people. However, the data may not be directly shown in the display. A display card is required to transform the data to a data with displayable format for displaying on a display.

However, typically, the Internet or TV cable line is only installed in the living room. Therefore, if the computer is placed in another room, an additional line is required. Installing another line is inconvenient for a user.

FIG. 1 illustrates a typical method for resolving the foregoing problem. A wireless module 104 is connected to the display card 102 and the video card 103 of a computer 100. Another wireless module 108 is connected to a television 106. Then, the user switches the frequency key 110 and 112 by hand to modify the transmission frequency between the wireless modules 104 and 108 so that the data is transformed in a negotiated frequency. Then, the data of the computer 100 is transferred to the television 106 using the negotiated frequency through wireless communication. Therefore, even though a television and a computer are located in different rooms, a user may still get the data shown in the computer through the television without having to install another line.

Although the foregoing method may resolve the need to install an additional line, an additional wireless module is required to connect with the display card. Such a structure enlarges the computer volume. Moreover, the frequency key of the typical wireless module is modified by hand. Once the transmission frequency is interfered with, the user has to adjust the frequency key again. Therefore, the typical method is very inconvenient for a user to use when there is frequent interference. Furthermore, only one-way communication is provided by the typical method. Therefore, a user cannot directly control the computer from the television. Once additional data is required by the user, he has to go to the computer to process the change, thus making the typical method even more inconvenient.

### SUMMARY OF THE INVENTION

Therefore, it is the main purpose of the present invention to provide a display card with a wireless module.

Another purpose of the present invention is to provide a display card with a transmission frequency that can be modified in real-time by a software program.

Yet a further purpose of the present invention is to provide a display card with a wireless module providing two-way communication.

Accordingly, the present invention provides a display card with wireless communication functionality. A wireless module controlled by a graphic processing unit is formed in the display card. Audio-visual information is sent to the corresponding display through a wireless communication method by the display card. This display card can communicate with the motherboard through an interface. A software program is used to modify the transmission frequency.

The present invention provides a method of using a software program to modify the transmission frequency. A user first issues a switching frequency requirement through a user interface to the central processing unit (CPU) in the motherboard. The CPU notifies the graphic processing unit (GPU) in the display card to control the wireless module thereof to switch the transmission frequency to a best frequency. At this time, the graphic processing unit also controls the wireless module of the corresponding display to change its transmission frequency to the best frequency.

In another embodiment, an additional indicator is installed in the wireless module of the corresponding display. The user can use the indicator to input instructions. These instructions may be sent to the computer through the wireless module.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a typical system to send data between a computer and a television through wireless communication;

FIG. 2 illustrates a system of the present invention to send data between a computer and a television through wireless communication;

FIG. 3 illustrates a display card with wireless communication functionality according to the present invention; and

FIG. 4 illustrates a flow chart of using a software program to modify the transmission frequency in real-time according to the present invention.

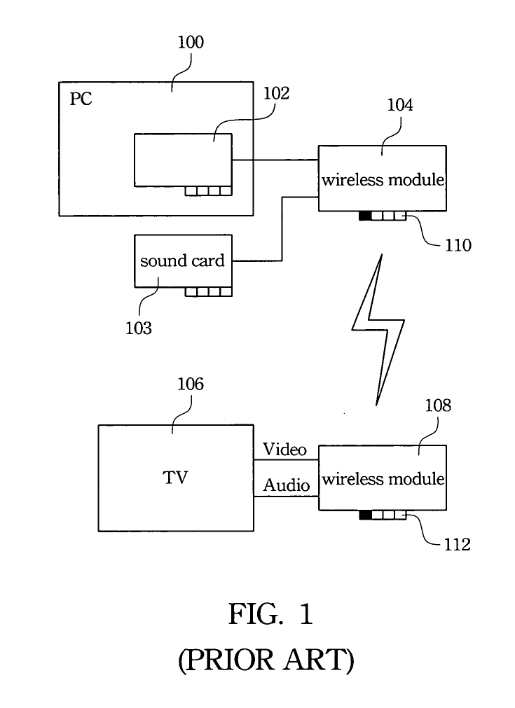

### DETAILED DESCRIPTION OF THE PREFERRED EMBODIMENT

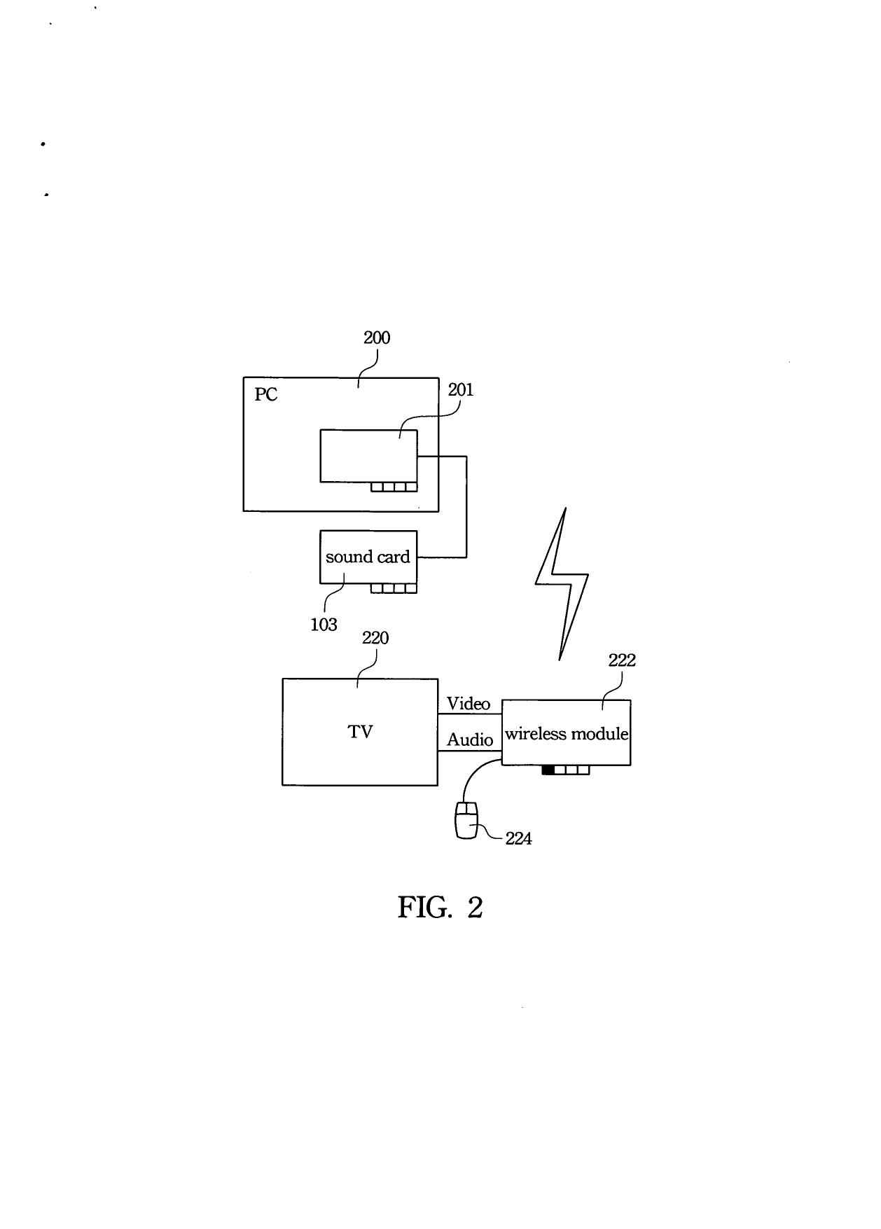

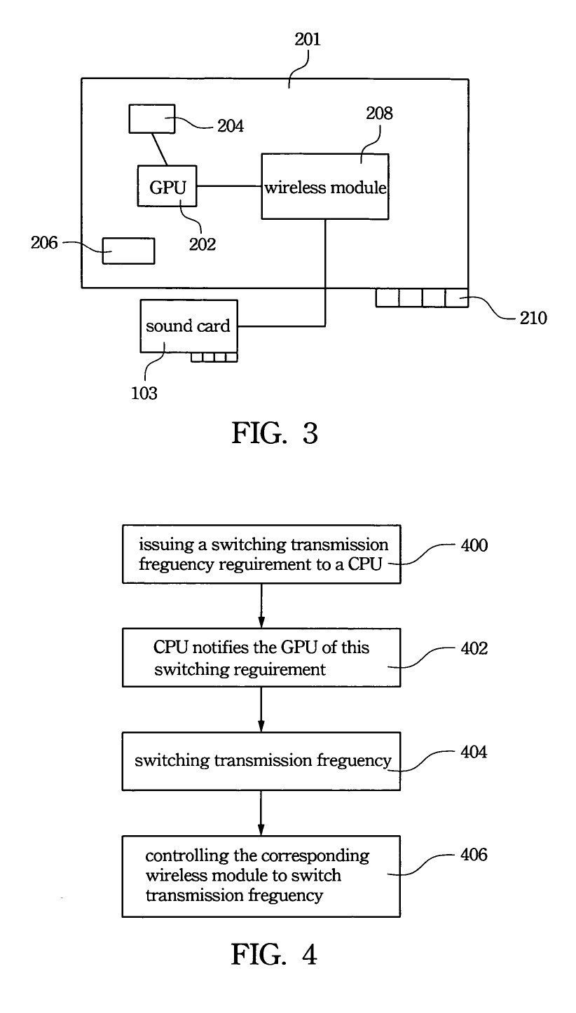

FIG. 2 and FIG. 3 illustrates a system of the present invention to send data between a computer and a television through wireless communication. According to the present invention, a first wireless module 208 is built in the display card 201 of the computer 200. A sound card 103 is also coupled to the first wireless module 208. A software program is used to switch the first transmission frequency between the computer 200 and the television 220. A second wireless module 222 is coupled to the television 220. An indicator 224, such as a mouse, an optical pen or any type of indicator, is coupled to the second wireless module 222 so as to communicate with the computer 200. According to the first transmission frequency, the first wireless module 208 may control the second wireless module 222 to switch its transmission frequency to a second transmission frequency. The first and second transmission frequency have the same frequency.

FIG. 3 illustrates a display card with wireless communication functionality according to the present invention. The display card includes a graphic processing unit (GPU) 202, memory 204, basic input/output system (BIOS) 206, a wireless module 208 and a bus 210. A sound card 103 is coupled to the wireless module 208.

The GPU 202 is used to process the graphic data for displaying in a display. The processed graphic data is stored in the memory 204. The memory 204 is an SDRAM, an SGRAM or a DDR SDRAM. The BIOS 206 is used to store the control program of the display chip with the driver, display card type and do on. An audio-visual data is sent to the corresponding display through a wireless module 208. According to the preferred embodiment of the present invention, the display is a television. However, other types of displays may also be used in the present invention. The wireless module 208 is coupled to the GPU 202. The GPU 202 may control the wireless module 208 so as to send audio-visual data to the television. The communication between the display card 201 and the motherboard of the computer (not shown in the figure) is through the bus interface 210 for exchanging data. The interface is an AGP interface, PCI interface, PCI-E interface or other interface.

Referring to FIG. 2 again, the transmission frequency between the two wireless modules 208 and 222 is modified first so as to search out a first transmission frequency to avoid being interfered with during when the audio-visual data of the computer 200 is sent to the remote television 220.

FIG. 4 illustrates a flow chart of using a software program to search for the first transmission frequency in real-time according to the present inveniton. First, in step 400, after a user issues a channel switching requirement through a user interface, the CPU in the motherboard informs the GPU 202 of this requirement in the display card 201 in step 402. The GPU 202 controls the wireless module 208 to search out a transmission frequency in step 404. Next, in step 406, after the wireless module 208 has sought out a best transmission frequency, it notifies the wireless module 222 of the best transmission frequency. Then, the wireless module 222 switches its transmission frequency according to this notification so that the computer 200 and the television 220 may communicate to each other according to the best transmission frequency. In other embodiments, the transmission frequency may be modified automatically based on the transmission environment. In other words, when an audio-visual data is ready to be sent out, the software program of the present invention can automatically issue a transmission requirement to the CPU. Then, the CPU can inform the GPU of the transmission requirement, and the GPU can then control the wireless module to switch to a first transmission frequency.

After the first transmission frequency is determined, the audio-visual data of the computer 200 is sent to the television 220 based on the first transmission frequency. Then, through the television 220, the user can understand the audio-visual data of the computer 200. Through the indicator 224 coupled to the wireless module 222, he can directly operate the computer 200 on the screen of the television 220. For example, according to an embodiment, a virtual keyboard or a command window is shown on the screen of the television. Then, the user can use the indicator 224 to input his requirement. After a requirement is inputted, the wireless module 222 sends this requirement to the wireless module 208 of the computer 200 to process. After the computer 200 processes this requirement, the resultant data is sent to the television 220 through the wireless module 208 to display in the television 220. Therefore, a two-way communication may be reached.

According to a preferred embodiment of the present invention, a basic wireless transmission frequency is 2.4 GHz and is changed by 0.01 GHz. The control order is transmitted based on 2.401 GHz. When processing a wireless communication, the CPU in the mother board notifies the GPU to control the wireless module 208 to switch its transmission frequency. After the wireless module 208 receives this order, it will use 0.01 GHz as a unit to change its transmission frequency based on 2.4 GHz for searching a best transmission frequency. For example, if the best transmission frequency is 2.42 GHz, a notification transmitted in 2.401 GHz frequency is sent to the television 220 to inform the wireless module 222 to make a corresponding transmission frequency response. Therefore, a two-way communcation using 2.42 GHz transmission frequency between the television 220 and the computer 200 can be reached.

Accordingly, the wireless module of the present invention is built in the display card. The transmission frequency of the wireless module is switched by a software program. Therefore, the present inveniton can not only reduce the whole volume but also make a real-time transmission frequency response to avoid environmental interference. Moreover, an indicator is installed in the television. The user can use this indicator to input requirements on the screen of the television to be communicated to the computer, which is real two-way communication.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. A display card used in a computer system having a frequency adjusting program, comprising:
a graphic processing unit for processing an audio-visual data; and
a first wireless module coupling with said graphic processing unit for transmitting a processed audio-visual data to a display, wherein said graphic processing unit receive an order from said frequency adjusting program to control a first transmission frequency of said first wireless module.

2. The display card of claim 1, further comprising a memory for storing said processed audio-visual data.

3. The display card of claim 1, wherein said display is a television.

4. The display card of claim 1, wherein said display has a second wireless module, and said first wireless module may control said second wireless module to switch to a second transmission frequency related to said first transmission frequency.

5. The display card of claim 4, wherein said first transmission frequency is equal to said second transmission frequency.

6. The display card of claim 4, wherein said second wireless module further comprises an indicator.

7. The display card of claim 6, wherein said second wireless module may transmit a requirement inputted by said indicator to said first wireless module.

8. A computer system, wherein said system comprises:
a motherboard having a central processing unit;
a software program for controlling said central processing unit to send an adjusting frequency requirement; and
a display card coupling with said motherboard, wherein said display card comprises:
a graphic processing unit for processing an audio-visual data from said central processing unit and said adjusting frequency requirement, and also for sending an adjusting frequency signal; and
a first wireless module coupling with said graphic processing unit, and after receiving said adjusting frequency signal, said first wireless transmission adjusts its transmission frequency to a first transmission frequency for transmitting a processed audio-visual data to a display.

9. The computer system of claim 8, further comprising a memory for storing said processed audio-visual data.

10. The computer system of claim 8, wherein said display is a television.

11. The computer system of claim 8, wherein said display has a second wireless module, said first wireless module may control said second wireless module to switch to a second transmission frequency related to said first transmission frequency.

12. The computer system of claim 11, wherein said first transmission frequency is equal to said second transmission frequency.

13. The computer system of claim 11, wherein said second wireless module further comprises an indicator.

14. The computer system of claim 13, wherein said second wireless module may transmit a requirement inputted by said indicator to said first wireless module.

15. A wireless transmitting system, wherein said system comprises:
a host with a display card and a software program, wherein said display card has a first wireless module controlled by said software program, said software program controls said first wireless module to adjust its transmission frequency to a first transmission frequency for transmitting an audio-visual data generated by said host; and
a display having a second wireless module for receiving an audio-visual data from said first wireless module, wherein said first wireless module control said second wireless module to switch to a second transmission frequency related to said first transmission frequency

16. The wireless transmitting system of claim 15, wherein said host is a computer system.

17. The wireless transmitting system of claim 15, wherein said host further comprises a memory for storing said processed audio-visual data.

18. The wireless transmitting system of claim 15, wherein said display is a television.

19. The wireless transmitting system of claim 15, wherein said second wireless module further comprises an indicator.

20. The wireless transmitting system of claim 19, wherein said second wireless module may transmit a requirement inputted by said indicator to said first wireless module.
